(19) United States
(12) Patent Application Publication
(10) Pub. No.: US 2002/0103633 A1
(43) Pub. Date: Aug. 1, 2002

(54) National language database for operating systems and method of using same

(76) Inventors: Bert Gasper, Johson City, NY (US); Peter Maceda, Binghamton, NY (US)

Correspondence Address: Christine Johnson, UNIVERSAL INSTRUMENTS CORPORATION, P.O. Box 825, Binghamton, NY, 13902-0825, US

(21) Appl. No.: 10/005,154

(22) Filed: Dec. 7, 2001

Related U.S. Application Data
(60) Provisional application No. 60/264,740, filed on Jan. 29, 2001.

(51) Int. Cl. G06F 17/20

(52) U.S. Cl. 704/8

(57) ABSTRACT

An operating system for a machine which displays text during machine operation includes a machine control operating system; a user operating system enabling operation of the machine control operating system by an operator of the machine, the user operating system including one or mores lines of code that incorporate text using unique identifiers; a library containing a plurality of lines of text in a first language for use by the user operating system, wherein each of the plurality of lines of text is referenced by one of the unique identifiers; a national language database storing a plurality of lines of text in a second language, the second language being different than the first language, wherein each of the plurality of lines of text is referenced by one of the unique identifiers; and an editor for specifying one of the first and second languages, so that the user operating system incorporates the text in the specified language.

### CROSS-REFERENCE TO RELATED APPLICATION

The present application claims the benefit of Provisional Application Serial No. 60/264,740, which was filed in the U.S. Patent and Trademark Office on Jan. 29, 2001, the entire contents of which is incorporated herein.

### BACKGROUND OF THE INVENTION

1. Field of the Invention

The present invention relates to software for assembly machines, and in particular, to software for assembly machines intended to be used with a plurality of languages.

2. Description of Related Art

The present invention may have applicability to a large number of machines or operating systems intended to be operated by software which, from time to time, requires text to be displayed on a screen, or in some other format. In a particular application, the present invention is used in assembly machines wherein text is displayed in a menu or dialogue box, wherein the text is relied upon by either an operator, service personnel, or both. Although a particular embodiment of the present invention is used on assembly machines intended to assemble electronic components on a printed circuit board, the present invention may have applications in other types of machines, as well.

Automated machinery is frequently shipped to various countries all around the world. For example, one particular model may be used in the United States, as well as in South America, where Spanish is predominantly spoken, and also in China or Taiwan where Chinese is spoken. As a convenience to users in respective countries, machines are frequently programmed so that when text is displayed on a monitor, the text is displayed in the local language of the machine operators. Use of a local language reduces training requirements and increases the convenience of the machine for the operator. It also lowers the skill level needed to operate the machine.

However, from time to time, it is necessary to service the machine. In some cases, service personnel from a different country may be dispatched to the foreign country to service a machine in the foreign country. In view of the fact that the service personnel may not be able to read the local language in which the particular machine is programmed, servicing of the machine can be difficult.

In addition, if a machine which has been used in one country is subsequently sold for use in another country, wherein a different language is used, reprogramming of the machine may be required in order to maintain the above-mentioned convenience of having the machine utilize the local language.

### OBJECTS AND SUMMARY

Accordingly, it is an object of the present invention in order to provide an operating system for a machine, wherein text is displayed on the machine monitor in a local language.

It is a further object of the present invention to provide an operating system for a machine, wherein the language used by the machine to interface with the operator can be easily changed from one language to another.

For example, it is an object of the present invention to provide a system wherein the language used by the operator of the system can be changed without having to change, reinstall, or recompile the software.

According to one embodiment of the present invention, an operating system for a machine which displays text during machine operation comprises a machine control operating system; a user operating system enabling operation of the machine control operating system by an operator of the machine, the user operating system including one or mores lines of code that incorporate text using unique identifiers; a library containing a plurality of lines of text in a first language for use by the user operating system, wherein each of the plurality of lines of text is referenced by one of the unique identifiers; a national language database storing a plurality of lines of text in a second language, the second language being different than the first language, wherein each of the plurality of lines of text is referenced by one of the unique identifiers; and an editor for specifying one of the first and second languages, so that the user operating system incorporates the text in the specified language.

A method of displaying text during operation of an operating system according to one embodiment of the present invention comprises specifying one of a first language and a second language; running a user operating system, the user operating system including one or mores lines of code that incorporate text using unique identifiers; a library containing a plurality of lines of text in the first language for use by the user operating system, wherein each of the plurality of lines of text is referenced by one of the unique identifiers; a national language database storing a plurality of lines of text in the second language, the second language being different than the first language, wherein each of the plurality of lines of text is referenced by one of the unique identifiers; incorporating the text in the specified language; and displaying the text in the specified language.

### BRIEF DESCRIPTION OF THE DRAWING

FIG. 1 is a schematic diagram illustrating an assembly machine and a control system therefore incorporating a preferred embodiment of the present invention.

FIG. 2 is a flowchart showing an operation of the preferred embodiment of the present invention.

### DETAILED DESCRIPTION OF THE PREFERRED EMBODIMENTS

The present invention relates primarily to an assembly machine, and more broadly to any type of machine, wherein information concerning the operation or servicing of the machine is displayed on a monitor for the operator or service personnel to use. Although a specific application of the present invention relates to assembly machines for assembling electronic components on circuit boards, the present invention may have applicability to a large number of other types of machines. In fact, the general principles of the present invention could be used on most types of computer operating systems, even those that are not used to control a machine.

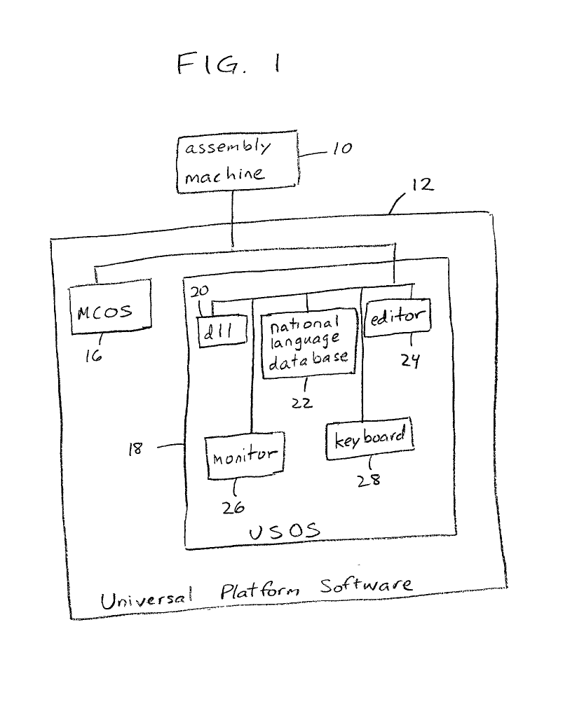

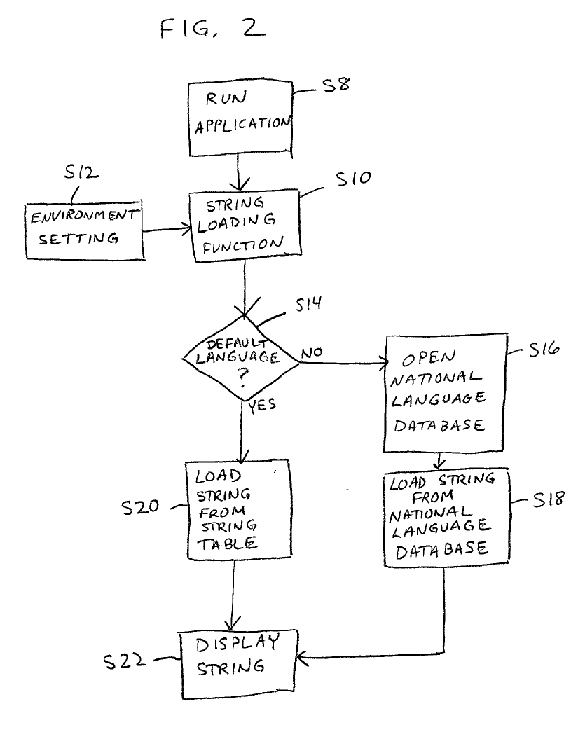

FIG. 1 is a schematic diagram illustrating a particular application of the present invention. FIG. 2 is a flowchart illustrating an operation sequence of a preferred embodiment of the present invention. The assembly machine 10 is illustrated schematically by a blank box. However, in actual use, the assembly machine 10 can be any one of a number of machines.

A control system 12, referred to generally as the Universal Platform System (UPS) is integral with the assembly machine, or, alternatively, connected thereto through an appropriate communications device, either wired or wireless. In the preferred embodiment, the control system 12 is included in a computer that is built into the assembly machine 10.

The control system UPS 12 includes a number of software programs or packages. Such programs include at least two basic components. The first basic component, referred to as the Machine Control Operating System MCOS) 16, directly controls the actual operation of the assembly machine 10, including, for example, controlling movement of the robotic arms on the machine 10. As used herein, the MCOS 16 may be any conventional operating system already known to those of skill in the art of controlling machines. Accordingly, further details of the MCOS 16 are omitted.

The second basic component, referred to as the Universal Supervisory Operating System (USOS) 18, contains code for interfacing the MCOS 16 with an operator of the assembly machine 10. The USOS 18 includes a series of programs, some of which are known as classes. These classes use C++. However, other languages may be used instead of C++.

Many types of USOS are known to those of skill in the art of controlling machines. Accordingly, some details of the USOS 18 are omitted. Unless otherwise indicated herein, the omitted details are conventional and known to those of skill in the art.

The USOS 18 used in the preferred embodiment of the present invention includes, among other things, four classes that have been modified from the original Microsoft MFC (Microsoft Foundation Class) format. These four classes are referred to herein as CMenuNL, CDialogNL, CStringNL, and CPropertySheetNL. Each of those classes is used in place of the standard Microsoft MFC class that it is designed to replace. Specifically, CMenuNL is used to load and display the menus that are normally displayed at the top of any application. CDialogNL is used to load and display dialogs with which that the user interacts. CStringNL is used to load strings from a resource string table. And, CPropertySheetNL controls the use of property sheets. Each of the four classes is preferably included in the same dynamic link library (dll) 20, referred to as u_controls.dll. However, it is not necessary for all of the classes to be in the same dll.

Each of the four classes discussed above includes strings of code, some of which correspond to text intended for displaying useful information for the operator or service personnel. In the classes, each string of code has a unique identifier, referred to herein as a numerical identification number, which specifically identifies that particular string of code. In the preferred embodiment, the text for a particular string of code is stored with the corresponding numerical identifier in the same dll 20 as the four classes. However, the text may be in other dll files. It is not necessary that it be in the same dll as the class. In addition, it is not necessary that all of the text be in one dll file. The text can be in two or more dll files. Such text is usually written and stored in English. In the preferred embodiment of the present invention, the default language is English. However, the default language could be any other language, if desired.

In operation, the program, relying on the numerical identification number, obtains the appropriate text from the appropriate dynamic link library, e.g., u₁₃ controls.dll 20, and displays the corresponding text.

One aspect of the present invention involves the use of a national language database 22. The national language database 22 includes a table having in one column the numerical identification number for each string of code used in any of the aforementioned classes that corresponds to text. In another column is a translation of the text in a foreign language. For example, in the first column of the table are listed the various numerical identifiers used in the USOS 18 classes to identify particular strings of code in the operating system. In a second column is the appropriate text relating to the particular string of code relating to that numerical identifier expressed in a particular language, such as Spanish or Chinese, for example. A third column of the table in the National language database 22 includes the appropriate text for each particular numerical identifier in a second language, such as Japanese.

Various embodiments of the present invention can be envisioned by one of ordinary skill in the art, wherein the national language database 22 might have a different number of columns and a different combination of languages. The present invention is not limited to use with any particular languages. The national language database 22 may support only one language, or it may support a number of languages. In the preferred embodiment, the national language database is created as an access database. However, other formats may be used for creating a national language database.

For convenience, the national language database may also include a column for the default language. However, such a column is primarily for the convenience of the translator. The operating system does not use the default text from the national language database in the preferred embodiment.

The Universal Platform System 12 also includes an interface software program, referred to herein as the environment editor 24. The environment editor 24 is a separate executable program, and is used during setup of the machine 10. Among other things, the environment editor 24 is used to set a flag in the systems registry which identifies the language to be used by the machine operator.

If the flag is set for the default language, e.g., English in the preferred embodiment, when a class encounters a string that references text, the program looks to the appropriate dll file for the corresponding English text to be used.

However, if the flag is set for a language other than the default language, when a class encounters a string that references text, the program looks to the national language database 22. The program finds the text in the specified language that corresponds to the numerical identifier in the string and uses that text. If the specified language uses an alphabet other than Roman, the system utilizes fonts from nationalized versions of Windows NT.

If a particular string cannot be located in the national language database 22, the system then looks to the default text in the appropriate dll.

With reference to FIG. 2, when the operating system is being run (S8), the program will encounter one or more string loading functions (S10). The string loading function looks to the flag set in the system registry (S12) to determine whether the text to be used is the default language or some designated nondefault language (14). If the system registry flag designates the default language, the system obtains the appropriate string from the default string table in the appropriate dll (S20). If the designated language is other than the default language, the system obtains the appropriate string from the national language database (S16) and loads the string from the designated column in the national language database (S18). In either way, the string is displayed in the specified language (S22).

If the national language is to be changed, either to enable service personnel from another country to use the machine, or if an operator speaking a different language is to use the machine, the environment editor 22 is used to reset the flag in the systems editor so that it selects the appropriate text from a different column in the national language database, referencing a particular designated national language.

If a new language capability is to be added to the machine, it is not necessary to reprogram all of the software. It is only necessary to replace the national language database 22 with one that includes the desired language. The national language database 22 can be downloaded from the internet or provided on a CD rom, or other appropriate medium.

The UPS 12 further includes a monitor 26 and a keyboard 28 for enabling the operator or service personnel to use the system.

In an alternative embodiment of the invention, instead of having the default language stored in a separate file from the national language database, all of the translated strings are stored in one database.

Although only preferred embodiments are specifically illustrated and described herein, it will be appreciated that many modifications and variations of the present invention are possible in light of the above teachings and within the purview of the appended claims without departing from the spirit and intended scope of the invention.

What is claimed is:

1. An operating system which displays text during operation, the operating system comprising:
a user operating system including one or mores lines of code that incorporate text using unique identifiers;
a national language database storing a plurality of lines of text in a first language and a second language, the second language being different than the first language, wherein each of the plurality of lines of text is referenced by one of the unique identifiers; and
an editor for specifying one of the first and second languages, so that the user operating system incorporates the text in the specified language.

2. The operating system of claim 1, wherein the user operating system includes a systems registry and the editor sets a flag in the systems registry identifying the specified language.

3. An operating system for a machine which displays text during machine operation, the operating system comprising:
a machine control operating system;
a user operating system enabling operation of the machine control operating system by an operator of the machine, the user operating system including one or mores lines of code that incorporate text using unique identifiers;
a library containing a plurality of lines of text in a first language for use by the user operating system, wherein each of the plurality of lines of text is referenced by one of the unique identifiers;
a national language database storing a plurality of lines of text in a second language, the second language being different than the first language, wherein each of the plurality of lines of text is referenced by one of the unique identifiers; and
an editor for specifying one of the first and second languages, so that the user operating system incorporates the text in the specified language.

4. The operating system of claim 3, wherein the library contains a default language which is to be used if the text in the specified language cannot be found in the national language database.

5. The operating system of claim 3, wherein the national language database further contains an additional plurality of lines of text in a third language, the third language being different than the first language and the second language, wherein each of the additional plurality of lines of text is referenced by one of the unique identifiers.

6. The operating system of claim 5, wherein the library contains a default language which is to be used if the text in the specified language cannot be found in the national language database.

7. The operating system of claim 3, wherein the user operating system and the library are both contained in a same dynamic link library.

8. The operating system of claim 6, wherein the user operating system and the library are both contained in a same dynamic link library.

9. The operating system of claim 3, wherein the user operating system includes a systems registry and the editor sets a flag in the systems registry identifying the specified language.

10. The operating system of claim 8, wherein the user operating system includes a systems registry and the editor sets a flag in the systems registry identifying the specified language.

11. An operating system for a machine which displays text during machine operation, the operating system comprising:
a machine control operating system;
a user operating system enabling operation of the machine control operating system by an operator of the machine, the user operating system including one or mores lines of code that incorporate text using unique identifiers;
a national language database storing a plurality of lines of text in a first language and a second language, the second language being different than the first language, wherein each of the plurality of lines of text is referenced by one of the unique identifiers; and
an editor for specifying one of the first and second languages, so that when the user operating system is operating, the user operating system incorporates the text in the specified language.

12. The operating system of claim 11, wherein the user operating system includes a systems registry and the editor sets a flag in the systems registry identifying the specified language.

13. A method of displaying text during operation of an operating system, the method comprising:
specifying one of a first language and a second language;
running a user operating system, the user operating system including one or mores lines of code that incorporate text using unique identifiers;
a library containing a plurality of lines of text in the first language for use by the user operating system, wherein each of the plurality of lines of text is referenced by one of the unique identifiers;
a national language database storing a plurality of lines of text in the second language, the second language being different than the first language, wherein each of the plurality of lines of text is referenced by one of the unique identifiers;
incorporating the text in the specified language; and
displaying the text in the specified language.

14. The method of claim 13, wherein the operating system includes a systems registry and the specifying step includes setting a flag in the systems registry to identify the specified language.

15. A method of displaying text during operation of an operating system, the method comprising:
specifying one of a first language and a second language;
running a user operating system, the user operating system including one or mores lines of code that incorporate text using unique identifiers;
a national language database storing a plurality of lines of text in the first language and in the second language, the second language being different than the first language, wherein each of the plurality of lines of text is referenced by one of the unique identifiers;
incorporating the text in the specified language; and
displaying the text in the specified language.

16. The method of claim 15, wherein the operating system includes a systems registry and the specifying step includes setting a flag in the systems registry to identify the specified language.
